(19) United States
(12) Patent Application Publication
(10) Pub. No.: US 2007/0011885 A1
(43) Pub. Date: Jan. 18, 2007

(54) Media Cutting Tool

(75) Inventors: Scott D. Gullicks, Apple Valley, MN (US); Gerald E. Mueller, Eagan, MN (US); Joy A. Packard, Somerset, WI (US); Scott D. Pearson, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/456,983

(22) Filed: Jul. 12, 2006

Related U.S. Application Data
(60) Provisional application No. 60/699,744, filed on Jul. 15, 2005.

(51) Int. Cl. B26B 29/00

(52) U.S. Cl. 30/289

(57) ABSTRACT

The present invention relates to a media cutting tool for cutting a media. The media cutting tool comprises a cutting blade and a tool guide. The cutting blade is in a first plane and comprises a cutting edge. The tool guide is in a second plane. The tool guide and the cutting blade are of a similar composition and connect to form a unit. The first plane of the cutting blade and the second plane of the tool guide intersect at a connection line.

### CROSS-REFERENCE TO RELATED APPLICATIONS

The present invention claims the benefit of provisional application 60/699,744 titled “Media Cutting Tool” and filed on Jul. 15, 2005.

### FIELD OF INVENTION

The present invention relates to a cutting tool. In particular, the present invention relates to a media cutting tool that is well suited for incorporation into a media cutting device.

### BACKGROUND

There are a wide variety of devices available for cutting media such as paper, plastic sheets, aluminum foil, felt, and photos. Perhaps the most commonly used device for such media is the scissors. While scissors are commonplace, they do have some drawbacks. For example, scissors require two cutting blades that pivotally operate together to cut media. A user must be able to maneuver each of the cutting blades together. For people with arthritis or other conditions with limited range of motion in their hands or limited fine motor skills handling scissors may be difficult.

In many circumstances a user needs a tool that is maneuverable and has the ability to maintain a straight line or desired pattern. Often with scissors, it is difficult to maintain a straight line or desired pattern as one moves the scissors along the media. Envelope openers are available commercially, which are useful for cutting along a fold. However, they are not as well suited to cut media that does not contain a fold.

The blades used in envelope openers are typically a straight edge razor blade with no additional components to strengthen the cutting edge to limit flexing and twisting of the blade. Under sufficient stress, such blades may break.

What is needed is a cutting tool that is easily maneuvered by a user and avoids the scissor action with components to reinforce the blade to limit breaks caused by flexing and twisting.

### SUMMARY

The present invention provides for a light-weight, hand-held, portable media cutting tool for cutting straight lines, patterns, or curves on a media. The media cutting tool can be used in conjunction with a media cutting device. Exemplary media that may be cut with the media cutting tool includes, but is not limited to, paper (such as gift wrapping paper, wax paper, photopaper), plastic, metal film such as aluminum foils, fabrics such as felts, and cardboard.

The media cutting tool may minimize breaks in the cutting blade by minimizing flexing and twisting of portions of the cutting blade. Additionally, if the cutting tool is used in conjunction with a media cutting device, the cutting tool may prevent exposure of a sharp edge of the cutting blade to a user in the event portions of the media cutting device break.

When a user utilizes the media cutting tool over a working surface, such as a tabletop, countertop, or desk, the media cutting tool protects the sharp edge of the cutting blade from contacting the work surface. Typically, a cutting mat is used where the cutting tool has a blade that may contact and damage the work surface. With the media cutting tool, the user does not need to use a cutting mat to cut the media. Eliminating a cutting mat is especially useful in crafting applications.

The present invention relates to a media cutting tool for cutting media. In one embodiment, the media cutting tool comprises a cutting blade and a tool guide. The cutting blade is in a first plane and comprises a cutting edge. The tool guide is in a second plane. The tool guide and the cutting blade are of a similar composition and connect to form a unit. The first plane of the cutting blade and the second plane of the tool guide intersect at a connection line.

In another embodiment, the media cutting tool comprises a cutting blade and a tool guide. The cutting blade is in a first plane and comprises a leading edge point and trailing edge point. The tool guide is of a similar composition as the cutting blade and is connected to the cutting blade to form a unit. The tool guide comprises a leading projection and a lateral projection. A portion of the leading projection extends beyond the leading edge point of the cutting blade. The lateral projection projects laterally from the first plane of the cutting blade.

In another embodiment, a media cutting device comprises a body comprising a handle and a device guide extending from the handle. The media cutting device further comprises a media cutting tool comprising a cutting blade in a first plane and a tool guide in a second plane. The tool guide is connected to the cutting blade. The first plane of the cutting blade and the second plane of the tool guide intersect at a connection line. The cutting blade comprises a cutting edge that is exposed from the body to cut a media and a portion of the cutting blade is disposed in the body. The tool guide is disposed in the device guide.

### BRIEF DESCRIPTION OF THE DRAWINGS

FIG. 1 is a perspective view of an exemplary embodiment of a media cutting tool according to the present invention.

FIG. 2 is a front view of the media cutting tool of FIG. 1.

FIG. 3 is a side view of the media cutting tool of FIG. 1 incorporated into a media cutting device, shown in phantom.

FIG. 4 is a top view showing a substrate used in an exemplary embodiment of making a media cutting tool.

FIG. 5 is a top view showing a media cutting tool formed from the substrate shown in FIG. 4.

While the above-identified drawings and figures set forth embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of this invention. The figures may not be drawn to scale.

### DETAILED DESCRIPTION

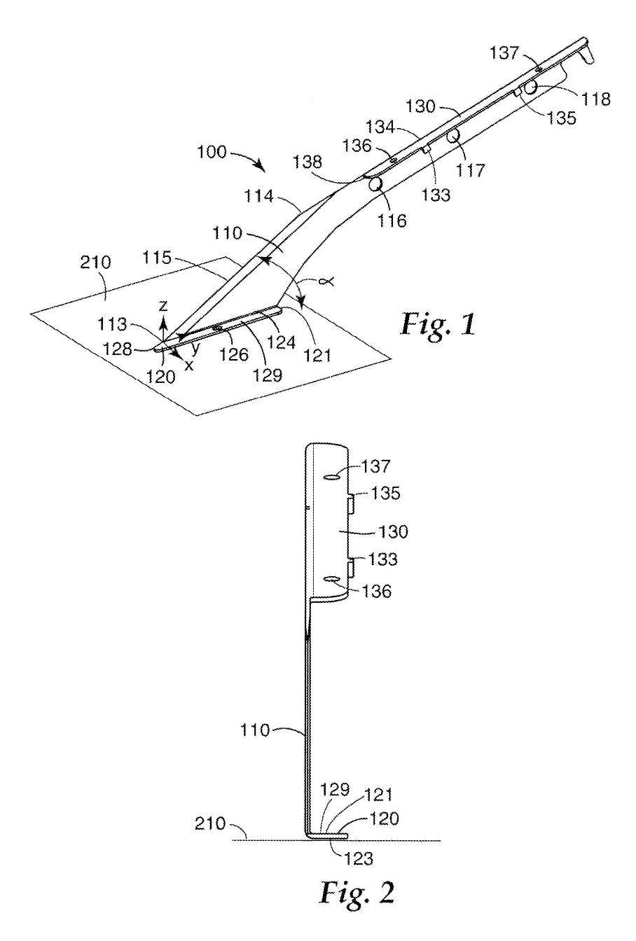

FIG. 1 is a perspective view of an exemplary embodiment of a media cutting tool 100 according to the present invention. The media cutting tool 100 shown in FIG. 1 comprises a cutting blade 110, a tool guide 120, and a handle portion 130. The media cutting tool 100 is shown positioned over a media surface 210 prior to cutting the media surface 210. The cutting blade 110 includes a cutting edge 115 that extends from a leading edge point 113 to a trailing edge point 114. Leading edge point 113 of the cutting edge 115 is at the intersection of the cutting edge 115 with the tool guide 120. Trailing edge point 114 of the cutting edge 115 is the end point of the cutting edge 115 opposite the leading edge point 113.

Typically, the cutting edge 115 form a line. In particular, the cutting edge 115 forms a straight line that is angled relative to the media surface 210. When the cutting edge 115 is angled, the leading edge 113 is closer than the trailing edge 114 to the media surface 210. In one embodiment, the cutting edge 115 is at an angle α of at least 5 degrees relative to the media surface 210. In one embodiment, the cutting edge 115 is at an angle α of between 5 degrees and 85 degrees. In another embodiment, the cutting edge 115 is at an angle α of approximately 27 degrees relative to the media surface 210.

The cutting blade 110 may be made from a variety of materials, including but not limited to metals, ceramics, and plastics. Suitable metals include, but are not limited to, stainless steel, cold rolled steel, cold rolled nickel plated steel, copper, and brass. The cutting blade 110 may have a thickness ranging from 0.008 inches (0.203 mm) to 0.025 inches (0.635 mm). Typically, the cutting edge 115 formed on the cutting blade 110 is a sharp edge. The cutting edge 115 may be formed from razor stock. In one embodiment, the cutting edge 115 is hardened to provide additional strength and durability to the cutting edge 115.

As shown, the cutting blade 110 and cutting edge 115 in particular forms a straight line and is chiseled, i.e., planar on one side and angled on the opposite side. However, the cutting blade 110 and cutting edge 115 may be of any type or of any geometry such as, but not limited to, straight, beveled, chiseled, serrated, corrugated, scalloped, curved or any combination thereof.

The tool guide 120 and the cutting blade 110 are of similar compositions. As with the cutting blade 110, the tool guide 120 may be made from a variety of materials, including metals, ceramics, and plastics. The composition of the tool guide 120 and cutting blade 110 are not required to be identical. Similar compositions are compositions having similar physical and chemical properties. For example, in one embodiment, the tool guide 120 and cutting blade 110 are both composed of metals. In another embodiment, the tool guide 120 and cutting blade 110 are both composed of plastics or are both composed of ceramic materials.

The tool guide 120 and the cutting blade 110 connect to form a unit. A unit is a single formed structure of a similar composition. In one embodiment, the tool guide 120 and cutting blade 110 are connected by a formed fold in the substrate, which comprises the tool guide 120 and cutting blade 110, along a connection line 124. The formed fold in the substrate provides a continuous connection between the tool guide 120 and the cutting blade 110 such that a separate attaching component is not necessary.

In an alternative embodiment, the tool guide 120 and cutting blade 110 are connected through mechanical or chemical means such as but not limited to ultrasonic welding, mechanical welding, mechanical clips, fixtures or fasteners, or adhesive, etc. The mechanical or chemical attachment is compatible with the composition of the tool guide 120 and cutting blade 110 to result in a single unit of a similar composition.

For reference purposes, a Cartesian coordinate system is used to define various planes of the media cutting tool 100. In a Cartesian coordinate system, intersecting axes X, Y, and Z meet at an origin. When the origin coincides with leading edge point 113, as shown in the embodiment of FIG. 1, then the tool guide 120 is in the X-Y plane. The cutting blade 110 is in the Z-Y plane, which is perpendicular to the X-Y plane of the tool guide 120. The handle portion 130 is generally planar and is perpendicular to the Z-Y plane of the cutting blade 110.

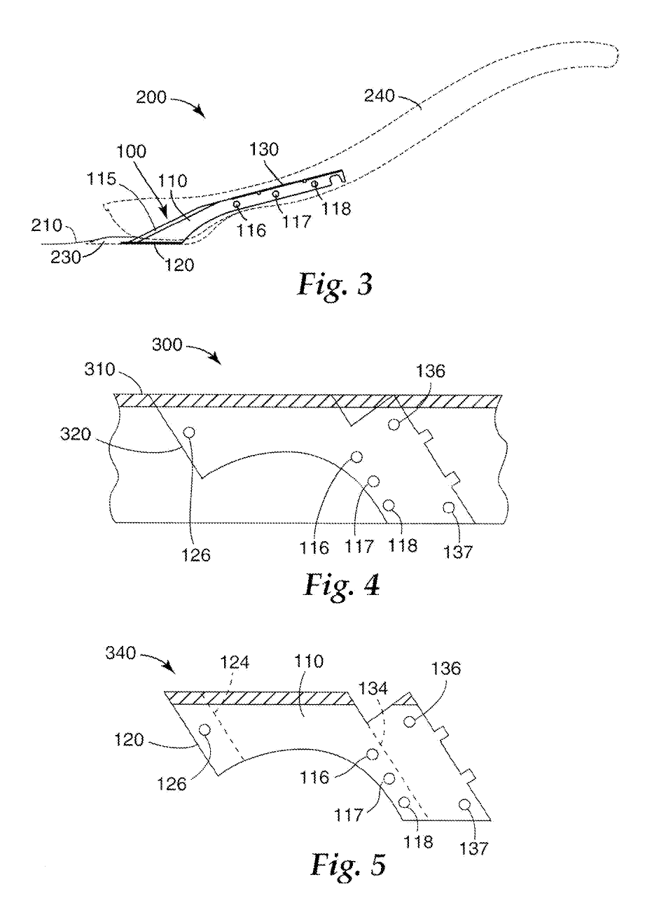

In the embodiment shown in FIG. 1, the tool guide 120 includes a projecting portion 128 and a lateral portion 129. The projecting portion 128 precedes and extends beyond the leading edge point 113 of the cutting edge 115 of the media cutting tool 100. The projecting portion 128 assists with lifting up the media surface 210 to be presented to the cutting edge 115 of the cutting blade 110 (see FIG. 3). The projecting portion 128 may have a portion aligned and extending directly beyond the leading edge point 112 of the cutting edge 115 of the cutting blade, or as shown in FIG. 1, may only extend beyond the cutting edge 115 but is not linearly aligned with the cutting edge 115.

The lateral portion 129 of the tool guide 120 projects laterally from the cutting blade (also see FIG. 2). As shown in FIG. 1, the projecting portion 128 and the lateral portion 129 are coplanar with one another and lie in the X-Y plane. However, the projecting portion 128 may be in a different plane than the lateral portion 129. For example, the projecting portion 128 may be inclined in a direction sloping towards the leading edge point 113 of the cutting edge 115 and therefore generally along the angle a of the cutting edge 115, while the lateral portion 129 is substantially parallel to the media surface 210. In other words, the projecting portion may be planar and inclined out of the X-Y plane in the Z direction.

The tool guide 120 includes a first surface 121 and a second surface 123, which is opposite the first surface 121 (see FIG. 2). The second surface 123 is planar and substantially parallel to the media surface 210. The first surface 121 is also shown in FIG. 1 to be substantially planar. If the media cutting tool 100 is used over a working surface, such as a tabletop, countertop, or desk, the planar second surface 123 assists with sliding the media cutting tool 100 across the working surface. Also, when the media cutting tool 100 is used over a working surface, the tool guide 120 protects the work surface from contact with the leading edge point 113 of the cutting edge 115 to prevent damage to the work surface and eliminate the need for a cutting mat.

A planar or nonplanar second surface 123 that is not parallel to the media surface 210 may also be used. Additionally, although the first surface 121 is also shown to be substantially planar and parallel with the second surface 123, the first surface 121 may be of any shape or configuration. In an alternative embodiment, the first surface 121 may be sloped or inclined toward the leading edge point 113 of the cutting edge 115 and therefore generally along the angle α of the cutting edge 115 to assist with presenting the media 210 to the cutting edge 115. In other words, the first surface 121 may be planar and inclined out of the X-Y plane in the Z direction. The second surface 123 may be planar and parallel with the first surface 121 or may be nonplanar and or nonparallel relative to the first surface 121.

The handle portion 130 is optional and is utilized particularly when the media cutting tool 100 is embedded within a media cutting device 200, as depicted in FIG. 3. The handle portion 130 connects to the cutting blade 110, distal to where the tool guide 120 connects to the cutting blade, and forms a unit. A unit is a single formed structure of a similar composition. As with the cutting blade 110 and the tool guide 120, the handle portion 130 may be of any material such as but not limited to metal, plastic, or ceramic.

In one embodiment, the handle portion 130 and cutting blade 110 are connected by a formed fold in the substrate, which comprises the handle portion 130 and cutting blade 110, along a fold line 134. The formed fold in the substrate provides a continuous connection between the handle portion 130 and the cutting blade 110 such that a separate attaching component is not necessary. The handle portion 130 is removed in the Y direction from the cutting edge 115 of the cutting blade 110, and particularly the handle portion 130 is removed in the Y direction from the trailing edge point 114 of the cutting edge 115.

In an alternative embodiment, the handle portion 130 and cutting blade 110 are of similar compositions and are connected through mechanical or chemical means such as, but not limited to, ultrasonic welding, mechanical welding, mechanical attachments, clips or fasteners, or adhesive, etc. The mechanical or chemical attachment is compatible with the composition of the handle portion 130 and cutting blade 110 to result in a single unit of a similar composition.

The handle portion 130 may include a first projecting tab 133 and a second projecting tab 135. Projecting tabs 133, 135 are used for positioning and alignment of the media cutting tool 100 during manufacturing. Projecting tabs 133, 135 are shown attached to the handle portion 130 and project perpendicularly relative to the handle portion 130. However, projecting tabs 133, 135 may be positioned in a number of ways relative to the media cutting tool 100 to assist with positioning and alignment of the media cutting tool 100 during manufacturing.

Cutting blade 110 may include first opening 116, second opening 117, and third opening 118. The tool guide 120 may include an opening 126, and the handle portion 130 may include first opening 136 and second opening 137. When the media cutting tool 100 is incorporated with a separate device, such as a media cutting device 200 as shown and described in FIG. 3, the first opening 116, second opening 117, and third opening 118 in the cutting blade, opening 126 in the tool guide 120, and first opening 136 and second opening 137 in the handle portion 130 provide a place for the media cutting tool 100 to secure with the media cutting device 200. The openings also assist with proper physical positioning of the media cutting tool 100 within a media cutting device 200.

It is understood that projecting tabs 133, 135, first opening 116, second opening 117, and third opening 118 in the cutting blade, opening 126 in the tool guide 120, and first opening 136 and second opening 137 in the handle portion 130 are optional. If included, any number of tabs and openings may be included and that the particular location and placement of the tabs and openings is not limited.

FIG. 2 is a front view of the media cutting tool 100 of FIG. 1. As can be seen, the cutting blade 110 is substantially planar in the Z-Y plane and is perpendicular to the media surface 210, which is in a X-Y plane, prior to cutting the media surface 210. The cutting blade 115 as shown in FIGS. 1 and 2 is also in the Z-Y plane and has a slope in the Z direction that increase from the leading edge point 113 to the trailing edge point 114 to form angle α However, to effectively cut the media 210 with the cutting blade 110, the cutting blade 110 may be in a plane other than directly within the Z-Y plane which extends at any angle relative to the media surface 210, other than parallel to the media surface 210.

As can be seen, the tool guide 120 projects from the cutting blade 1 10. In this embodiment, the lateral portion 129 of the tool guide 120 is perpendicular to the cutting blade 110 and is in the Y-X plane. However, in other embodiments, the tool guide 120 may project from the cutting blade 110 at any angle so long as the plane of the tool guide 120 intersects with the plane of the cutting blade 110. In other exemplary embodiments, the tool guide 120 projects from the cutting blade 110 at an angle greater than 5 degrees relative to the cutting blade 110.

In one embodiment, the projecting portion 128 of the tool guide 120 is in the plane of the tool guide 120. The projecting portion 128 may be any shape including, but not limited to, generally triangular (as shown in FIG. 1), rectangular, or curved. Alternatively, in other embodiments, the projecting portion 128 may be sloped, curved or inclined relative to the lateral portion 129 of the tool guide 120 such that either the first surface 121 or second surface 123, or both surfaces of the tool guide 120 would not be planar.

As shown in FIGS. 1 and 2, the handle portion 130 is substantially planar and projects from the cutting blade 110. In this embodiment, the handle portion 130 is perpendicular to the cutting blade 110. In this embodiment, the handle portion 130 is inclined out of the X-Y plane in the Z direction resulting in being inclined at an angle of approximately 15 degrees relative to the X-Y plane of the tool guide 120. Angles from 5 to 30 degrees may be used. However, other angles are within the scope of the present invention. Alternatively, the handle portion 130 may be parallel to the tool guide 120, and therefore as shown in this embodiment may be entirely within the X-Y plane. When a handle portion 130 is included, the handle portion 130 may project from the cutting blade 110 at any angle other than the 90 degree, perpendicular angle that is shown in FIGS. 1 and 2.

In the embodiments shown in FIGS. 1 and 2, the tool guide 120 and handle portion 130 extend from the same side of the cutting blade 1 10. However, the tool guide 120 may extend from one side of the cutting blade 110 while the handle portion 130 extends from an opposite side of the cutting blade 110. Additionally, either the tool guide 120 or the handle portion 130 or both may extend from both sides of the cutting blade 110.

Although the cutting blade 110, tool guide 120, and handle portion 130 are each shown to be substantially planar, it is within the scope of the present invention that each of these surfaces may be nonplanar, such as, but not limited to, curved or textured surfaces.

FIG. 3 is a side view of the media cutting tool 100 incorporated into a media cutting device 200, shown in phantom. The media cutting tool 100 of the present invention may be used to cut media or may be incorporated into a device such as a media cutting device 200 as shown and described in provisional application 60/673,824 titled “Media Cutting Device,” filed on Apr. 22, 2005, which is herein incorporated by reference or as shown and described in provisional application 60/699,905 titled “Media Cutting Device,” filed on Jul. 15, 2005, which is herein incorporated by reference.

As shown in FIG. 3, the media cutting tool 100 is disposed in the media cutting device 200 such that cutting edge 115 of the cutting blade 110 is exposed to the media surface 210 presented to be cut. The media cutting tool 100 may be permanently place within the media cutting device 200 (as describe below) or may be replacable (such as described in U.S. patent application Ser. No. 11/408,781 filed on Apr. 21, 2006).

The media cutting device 200 includes a handle 240 and a device guide 230 projecting from the handle 240. In this particular embodiment, leading edge point 113 of the cutting blade 115 lies near the tool guide 120, while trailing edge point 114 lies near the handle portion 130. The handle 240 of the media cutting device 200 encases and secures the handle portion 130 of the media cutting tool 100. The first opening 136 and second opening 137 of the handle portion 130 (see FIG. 1) and the first opening 116, second opening 117, and third opening 118 of the cutting blade 110 assist with anchoring the media cutting tool 100 to the handle 240 of the media cutting device 200. In this embodiment, injection molded plastic fills these openings. However, other types of chemical or mechanical fasteners are within the scope of the present invention for securing the media cutting tool 100 to the media cutting device 200, or the handle 240 of the media cutting device 200.

The tool guide 120 is disposed within the device guide 230 of the media cutting device. The tool guide 120 may provide structural support to the device guide 230. In this embodiment, injection molded plastic fills opening 126 (see FIG. 1) in tool guide 120 to anchor the media cutting tool 100 to the device guide 230 of the media cutting device 200.

Media 210 typically will be initially presented to the media cutting tool 100 by contacting the device guide 230 of the media cutting device 200. The device guide 230 and embedded tool guide 120 present the media 210 to the cutting edge 115 of the cutting blade 110. When the media cutting device 200 is used over a work surface, the device guide 230 and tool guide 120 protect the work surface from contact with the cutting edge 115.

The tool guide 120, being connected with the cutting blade 110 and having a portion not in the same plane as the cutting blade 110, reinforces the cutting blade 110 to reduce twisting, flexing, and the like, which may ultimately result in a damaged cutting blade 110. Also, when the media cutting tool 100 is incorporated into a media cutting device 200, which also has a device guide 230, the tool guide 120 strengthens the device guide 230 of the media cutting device 200 from breaking. In the event the device guide 230 of the media cutting device 200 does break, the tool guide 120 may provide a safety guard to prevent the user or a working surface from being directly exposed to the cutting edge 115.

When the media cutting tool 100 is incorporated with a media cutting device 200, the handle portion 130 assists with anchoring the media cutting tool 100 within the media cutting device 200. The leading edge 138 of the handle portion 130 is removed from the cutting edge 115 and in this embodiment is surrounded by the material of the handle (see FIG. 1). In other embodiments, the leading edge 138 may be encased by the material used to form the media cutting device 200 or the handle 240 of the media cutting device 200. The leading edge 138 while embedded in the media cutting device 200 creates a stop to help prevent the media cutting tool 100 from pulling out of the media cutting device 200.

The handle portion 130, when included, is typically not in the same plane as the cutting blade 100. As shown in the figures, the handle portion 130 is perpendicular to the cutting blade 100. Therefore, the handle portion 130 also provides additional strength to the cutting blade 100 to limit twisting and flexing of portions of the cutting blade 100, which may help prevent a damaged blade.

In one embodiment, the media cutting tool 100 of the present invention has an overall length of approximately 2.25 inches (5.7 cm) and an overall height of approximately 0.75 inches (1.9 cm). The cutting blade 110 has a thickness of approximately 0.008 inches (0.203 mm). The cutting edge 115 has a length of approximately 0.8 inches (2.0 cm). The cutting edge 115 is at an angle of approximately 27 degrees relative to the media surface 210. The tool guide 120 has a length of approximately 0.60 inches (1.5 cm). The lateral portion 129 extends perpendicularly from the cutting blade 110 by approximately 0.08 inches (0.2 cm). The handle portion 130 has a length of approximately 1.1 inches (2.8 cm) and extends perpendicularly from the cutting blade 110 by about 0.08 inches (0.2 cm).

In one method of making the media cutting tool 100 of the present invention, the media cutting tool 100 is constructed from a single piece of material. FIG. 4 is a top view showing a metal sheet 300 used in an exemplary embodiment for making a media cutting tool 100. The metal sheet 300 may be a continuous sheet of metal, such as razor stock, such that a series of media cutting tools 100 may be formed in a continuous process.

The metal sheet 300 includes a continuous cutting edge 310, which ultimately forms the cutting edge 115 of the cutting blade 110. A perimeter 320 of the media cutting tool 100 is stamped out of the metal sheet 300 to form a stamped tool 340 (see FIG. 5). The openings 116, 117, 118, 126, 136, and 137, if included, are also stamped out of the metal sheet 300.

FIG. 5 is a top view showing the stamped tool 340 cut from the metal sheet 300 shown in FIG. 4. The stamped tool 340 is folded along connection line 124 to form the tool guide 120 relative to the cutting blade 110. The stamped tool 340 is folded along fold line 134 to form the handle portion 130 relative to the cutting blade 110. The folded stamped tool 340 forms a media cutting tool 100. In this embodiment, cutting blade 110, tool guide 120, and handle portion 130 form a unit of the same composition, when the metal sheet 300 is of a single composition.

The metal sheet 300 is stamped and folded according to known processing techniques. Although one method of making a media cutting tool 100 using stamping and folding is described, other method of making a media cutting tool 110 according to the present invention may be used.

Although specific embodiments of this invention have been shown and described herein, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only by the structures described by the language of the claims and the equivalents of those structures.

What is claimed is:

1. A media cutting tool for cutting a media comprising:
a cutting blade in a first plane comprising a cutting edge; and
a tool guide in a second plane, the tool guide and the cutting blade are of a similar composition and connect to form a unit;
wherein the first plane of the cutting blade and the second plane of the tool guide intersect at a connection line.

2. The media cutting tool of claim 1, wherein the cutting edge is selected from the group consisting of a wire edge, beveled edge, chiseled edge, serrated edge, corrugated edge, scalloped edge, and curved edge or combinations thereof.

3. The media cutting tool of claim 1, wherein the cutting edge extends along a straight cutting line, wherein the cutting line is at an angle greater than 5° relative to the media cut with the media cutting tool.

4. The media cutting tool of claim 1, wherein the second plane of the tool guide is substantially perpendicular to the first plane of the cutting blade.

5. The media cutting tool of claim 1, wherein the similar composition of the cutting blade and the tool guide is selected from the group consisting of metal, plastic, and ceramic.

6. The media cutting tool of claim 1, further comprising:
a handle portion connected to the cutting blade distal to the tool guide to form a unit, wherein the handle portion projects laterally from the first plane of the cutting blade.

7. The media cutting tool of claim 6, wherein the handle portion is spaced from the cutting edge of the cutting blade.

8. The media cutting tool of claim 1 disposed in a media cutting device.

9. A media cutting tool for cutting media comprising:
a cutting blade in a first plane and comprising a leading edge point and trailing edge point; and
a tool guide of a similar composition as the cutting blade and connected to the cutting blade at the leading edge point to form a unit, the tool guide comprises a leading projection and a lateral projection;
wherein a portion of the leading projection extends beyond the leading edge point of the cutting blade; and
wherein the lateral projection projects laterally from the first plane of the cutting blade.

10. The media cutting tool of claim 9, wherein the cutting blade includes a cutting edge, wherein the cutting edge is selected from the group consisting of a wire edge, beveled edge, chiseled edge, serrated edge, corrugated edge, scalloped edge, and curved edge or combinations thereof.

11. The media cutting tool of claim 9, wherein the leading cutting edge extends along a straight cutting line, wherein the cutting line is at an angle greater than 5° relative to the media cut with the media cutting tool.

12. The media cutting tool of claim 9, wherein the similar composition of the cutting blade and tool guide is selected from the group consisting of metal, plastic, and ceramic.

13. The media cutting tool of claim 9, wherein the lateral projection projects substantially perpendicularly from the first plane of the cutting blade.

14. The media cutting tool of claim 9, wherein the lateral projection and the leading projection are coplanar in a second plane.

15. The media cutting tool of claim 14, wherein the second plane of the lateral projection and the leading projection intersects the first plane of the cutting blade.

16. The media cutting tool of claim 9, further comprising:
a handle portion connected to the cutting blade distal to the tool guide to form a unit.

17. The media cutting tool of claim 16, wherein the handle portion is generally planar.

18. The media cutting tool of claim 17, wherein the handle portion is substantially perpendicular to the first plane of the cutting blade.

19. The media cutting tool of claim 16, wherein the handle portion is generally planar and the tool guide is generally planar and wherein the handle portion is inclined relative to the tool guide at an angle of 5 to 30 degrees.

20. The media cutting tool of claim 16, wherein the handle portion is spaced from the trailing edge of the cutting blade.

21. The media cutting tool of claim 9 disposed in a media cutting device.

22. A media cutting device comprising:
a body comprising a handle and a device guide extending from the handle;
a media cutting tool comprising a cutting blade in a first plane and a tool guide in a second plane, the tool guide is connected to the cutting blade;
wherein the first plane of the cutting blade and the second plane of the tool guide intersect at a connection line;
wherein the cutting blade comprises a cutting edge that is exposed from the body to cut a media and a portion of the cutting blade is disposed in the body; and
wherein the tool guide is disposed in the device guide.

23. The media cutting tool of claim 21, wherein the cutting edge is selected from the group consisting of a wire edge, beveled edge, chiseled edge, serrated edge, corrugated edge, scalloped edge, and curved edge or combinations thereof.

24. The media cutting tool of claim 21, wherein the cutting edge is at an angle greater than 5° relative to the media cut with the media cutting device.

25. The media cutting tool of claim 21, wherein the second plane of the tool guide is substantially perpendicular to the first plane of the cutting blade.

26. The media cutting tool of claim 21, wherein the tool guide is connected to the cutting blade to form a unit.

27. The media cutting tool of claim 26, wherein the tool guide and the cutting blade are of a similar composition selected from the group consisting of metal, plastic, and ceramic.

28. The media cutting tool of claim 21, further comprising:
a handle portion connected to the cutting blade distal the tool guide to form a unit, wherein the handle portion is disposed in the handle of the body.

29. The media cutting tool of claim 28, wherein the handle portion is substantially perpendicular to the first plane of the cutting blade.

30. The media cutting tool of claim 28, wherein the handle portion is spaced from the cutting edge of the cutting blade.
